(19) United States
(12) Patent Application Publication
(10) Pub. No.: US 2012/0009827 A1
(43) Pub. Date: Jan. 12, 2012

(54) Electrical Component

(76) Inventors: Izumi Hasegawa, Kanagawa (JP); Takeshi Kimura, Kanagawa (JP)

(21) Appl. No.: 13/179,029

(22) Filed: Jul. 8, 2011

(30) Foreign Application Priority Data
Jul. 9, 2010 (JP) 2010-157144

(51) Int. Cl. H01R 24/00

(52) U.S. Cl. 439/660

(57) ABSTRACT

A surface mount type connector includes a housing, contacts and solder pieces. The contacts are secured to the housing and the solder pieces are secured to respective contacts. The solder pieces include flat sections that form a common plane across the contacts.

### CROSS-REFERENCE TO RELATED APPLICATIONS

This application claims the benefit of the filing date under 35 U.S.C. §119(a)-(d) of Japanese Patent Application No. JP 2010-157144, filed Jul. 9, 2010.

### FIELD OF THE INVENTION

The invention relates to an electrical connector and more particularly to a surface mount electrical connector.

### BACKGROUND

Surface mount electrical connectors are known, for instance, Japanese Patent Application Publication No. 10-162909 discloses a ball grid array type connector. This connector includes contacts extending from the inside to the outside of a housing, and solder balls. Taiwan utility model No. 383963 also discloses a ball grid array type connector.

In such connectors, in order to increase the number of pins and improve a surface mount area factor, the contact pitch has become higher. As the trend toward higher pitch advances, it has become increasingly important to align heights of plural portions of an electrical component which plural portions contacting a circuit board. This is because, in a case where the heights are not aligned and there is a portion that does not contact a contact point of the circuit board when mounted on the circuit board, even though a reflow process is applied, for instance, the portion may not be connected by soldering, thereby causing a connection failure.

In the connector disclosed in Japanese Patent Application Publication No. 10-162909, the installation positions of the solder balls are aligned by placing the solder balls in respective recesses formed in a housing. According to the connector disclosed in Taiwan utility model No. 383963, the solder balls are positioned by reception in the recesses of the contact.

However, according to the connectors disclosed in Japanese Patent Application Publication No. 10-162909 and Taiwan utility model No. 383963, unevenness occurs at a lower end position to be in contact with a circuit board because of an individual difference in size of the disposed solder balls, displacement of the recesses of the housing from a common plane, displacement of the contact from the common plane of the recesses and the like. In a case where a sufficient thickness of solder paste including flux (or only flux) is applied onto each conductor of the circuit board, such unevenness can be relieved by thickness of the solder paste. However, in response to the trend toward higher pitch, an area onto which solder paste is applied has become narrowed, even on the circuit board. Thus, the thickness of the solder paste cannot accommodate to such an extent, that unevenness of the lower end positions of the solder balls of the connector is relieved. This is because, since the thickness of a metal mask (stencil) used for selectively applying solder paste should be reduced by a narrowed amount of the width of the application area in order to secure application performance, the solder paste cannot be thicker than the metal mask.

The problem of a connection failure as a result of irregularities of the lower end positions caused by individual differences of the solder balls and the like is not limited to a connector. In fact, the problem is also common to electronic components, such as an IC sockets and an IC packages that have a configuration in which the solder balls for connection to a circuit board are attached to respective terminals.

### SUMMARY

The invention has been made in view of the above circumstances and provides an electrical connector to address the above problem among others and to suppress an occurrence of poor connection of a terminal when being surface-mounted on a circuit board.

The electrical connector according to the invention is a surface mount type connector and includes a housing, contacts and solder pieces. The contacts are secured to the housing. The solder pieces are secured to respective contacts. The solder pieces include flat sections that form a common plane across the contacts.

### BRIEF DESCRIPTION OF THE DRAWINGS

The invention is described in more detail in the following with reference to the embodiments shown in the drawings. Similar or corresponding details in the Figures are provided with the same reference numerals. The invention will be described in detail with reference to the following figures of which:

FIG. 1 is a perspective view of a connector according to the invention where a mating connector is received from above;

FIG. 2 is a perspective view of the connector of FIG. 1 when viewed from below;

FIG. 3 is an enlarged view of a part of contacts and solder balls of the connector shown in FIGS. 1 and 2;

FIG. 4 is a sectional view of the connector taken along line 4-4 in FIG. 3;

FIG. 5 is a diagram showing a method of manufacturing the connector shown in FIGS. 1 to 4;

FIG. 6 illustrates the connector shown in FIGS. 1 to 4 that is mounted on a circuit board;

FIG. 7 is a side view of a contact and a solder ball of a connector according to the invention;

FIG. 8 is a side view of another contact and a solder ball connection of the connector according to the invention;

FIG. 9 is a side view of another contact and a solder ball connection of the connector according to the invention;

FIG. 10 is a partial sectional view of another connector according to the invention;

FIG. 11 is a side view showing a manufacturing method of the connector shown in FIG. 10;

FIG. 12 is a side view of a contact and solder ball connection of the connector of FIG. 10;

FIG. 13 is a partial sectional view of another connector according to the invention;

FIG. 14 is a partial sectional view of another connector according to the invention; and

FIG. 15 is a partial sectional view of another connector according to the invention.

### DETAILED DESCRIPTION OF THE EMBODIMENT(S)

Exemplary embodiments according to the invention will be described with reference to drawings.

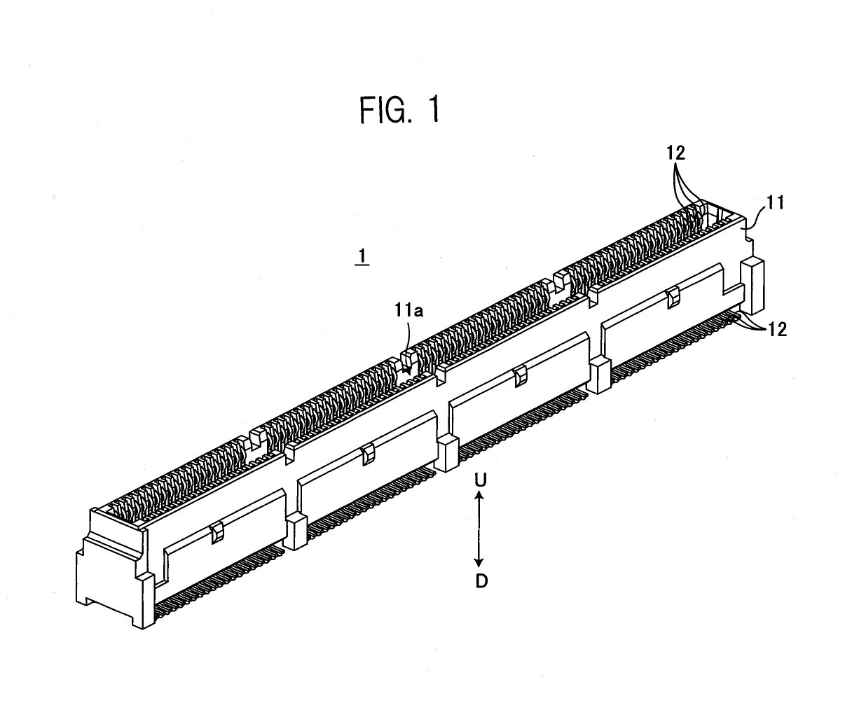

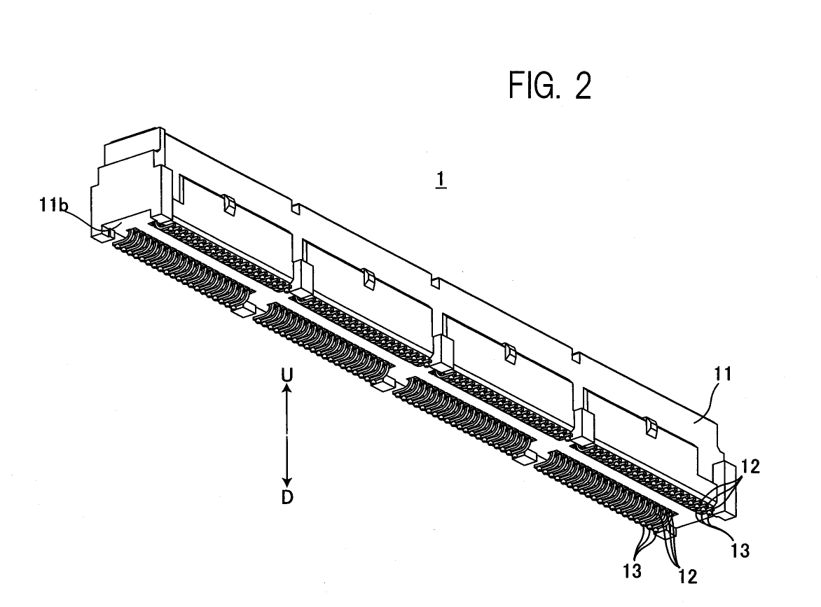

The connector 1 shown in FIGS. 1 and 2 is a surface mount electrical connector, and mounted on a surface of a circuit board to be used. The connector 1 is a so-called receptacle type connector, and electrically coupled to the mating connector (not illustrated), which is a plug type connector and includes a plate-like tip portion, by mating with the mating connector. The connector 1 includes a housing 11 supporting the structure itself of the connector 1, 160 pieces of contacts 12 secured to the housing 11, and solder balls 13 for soldering the respective contacts 12 to a circuit board. The housing 11 is a molded member made of an insulative resin material, and includes an elongated receiving passageway 11a extending along a longitudinal direction of the housing 11 for receiving the tip portion of the mating connector (not illustrated). Here, a direction of a side on which the receiving passageway 11a are provided of the connector 1 is referred to as an upward direction U; and a direction opposite to the upward direction is referred to as a downward direction D.

The contacts 12 are arranged in two rows each including 80 pieces, along inner surfaces on opposite sides of the elongated receiving passageway 11a, and contact with and are electrically coupled to the tip portion (not illustrated) of the mating connector inserted into the receiving passageway 11a. Each of the contacts 12 are formed by bending a rod-shaped body made of metal such as copper or copper alloy, penetrate the housing 11 from the receiving passageway 11a in an upward and downward direction UD, and protrude from the underside 11b of the housing 11. The tip portions of the contacts 12 protruding from the underside 11b of the housing 11 are bent to extend outward from the two rows along which the contacts 12 are arranged. When the connector 1 is mounted on a circuit board (not illustrated), the connector 1 is arranged in a mounting position in which the underside 11b of the housing 11 faces the circuit board. A portion of the contacts 12 that protrude from the underside 11b of the housing 11 are arranged to face the circuit board in the mounting position.

The solder balls 13 are attached to the respective tip portions of the contact 12 protruding from the underside 11b of the housing 11. The solder balls 13 are secured to the respective contacts 12 in an orientation facing the circuit board, that is, in a downwardly protruding state, in the mounting position. Each of the solder balls 13 does not have an entire spherical surface. Instead, a tip thereof facing the circuit board is formed flat.

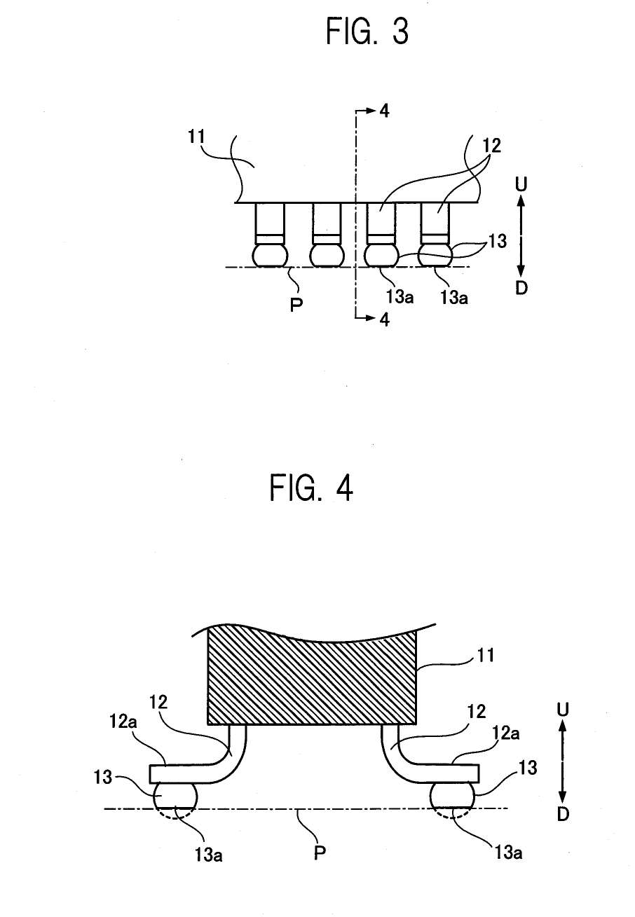

As shown in FIGS. 3 and 4, the solder balls 13 are secured to the respective contacts 12, protruding in the downward direction D, and include flat sections 13a facing downwardly. The flat sections 13a are flat surfaces, and form a plane (common plane) P common across the contacts 12. More specifically, the flat sections 13a of the solder balls 13 secured to all the contacts 12 of the connector 1 form the common plane P.

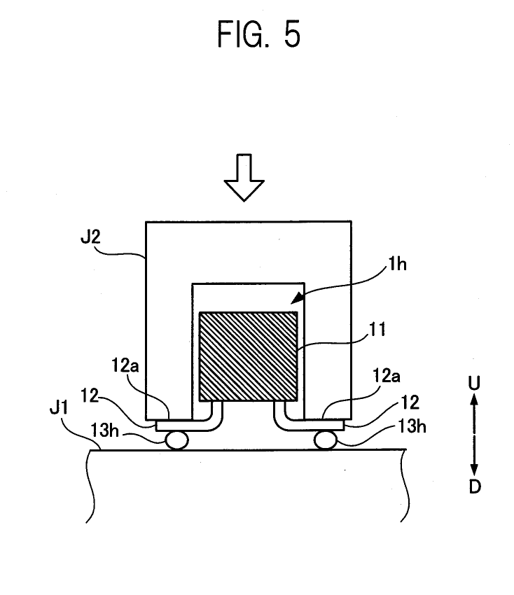

Each of the contacts 12 has a pressed section 12a against which a pressing tool J2 (see FIG. 5), which is described later, is pressed. In a process of manufacturing the connector 1, the pressing tool J2 (see FIG. 5) for pressing the solder balls 13 is pressed against the pressed section 12a avoiding the housing 11. More specifically, parts of the contact 12 that project from the underside 11b of the housing 11 and are bent and extend, protrude outward off sides of the housing 11. The solder balls 13 are secured to the thus protruded off portions.

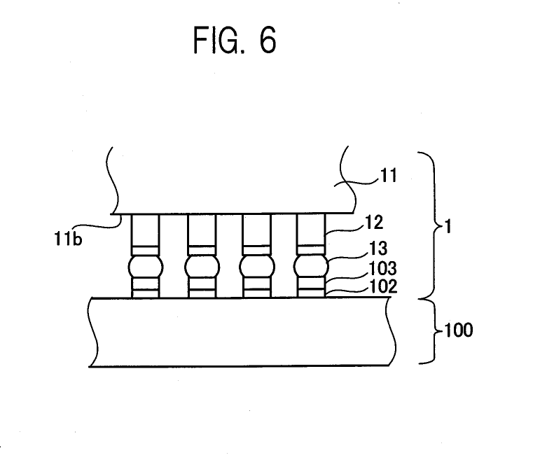

In the connector 1 shown in FIGS. 1 to 4, the flat sections 13a of the solder balls 13 secured to the respective contacts 12 form the common plane P. Therefore, in a case in which the connector 1 is mounted on the circuit board, all of the solder balls 13 come in contact with conductor traces 102 (see FIG. 6) of the circuit board.

Here, the housing 11 corresponds to an example of the insulating structure body according to the invention. The contact 12 corresponds to an example of the terminal according to the invention. The solder balls 13 correspond to an example of the solder pieces according to the invention.

In order to manufacture the connector 1 shown in FIGS. 1 to 4, first, the contacts 12 are attached to the housing 11, and then the solder balls are mounted on the respective contacts 12 in a state of holding an position vertically inverted from that shown in FIG. 1. The solder balls have a spherical shape at a stage of being mounted on the contacts 12, and are not provided with a flat plane. When the solder balls are mounted on the contacts 12, for instance, a method of putting a stencil provided with positioning openings at corresponding positions at which the respective solder balls are mounted and placing the solder balls at the positions of the respective openings, or a method of sequentially mounting the solder balls without using a stencil, are adoptable. The size (diameter) of the solder balls to be mounted on the contacts 12 typically has variation within 5% to 10%.

Next, when the solder balls are mounted on the respective contacts 12, heat is applied using an oven or the like and thereby the solder balls are fused and secured to the contacts 12.

FIG. 5 illustrates when the solder balls are secured to the contacts 12 and then vertically inverted in position.

In manufacturing the connector 1, next, a semi finished connector 1h, where the solder balls are secured to the contacts 12, is mounted on a flat tool J1. The flat tool J1 has a flat top surface and is made of material, such as iron or stone that is sufficiently harder than solder.

At the stage in which the semifinished connector 1h is mounted on the flat tool J1, each of the solder balls 13h is not necessarily contacted with the flat tool J1 owing to displacement of the contacts 12 from the common plane and a variation in size of each of the solder balls 13h. Some solder balls 13h may be apart from the flat tool J1.

Next, the pressing tool J2 is pressed against the pressed section 12a of the contacts 12, thereby pressing the solder balls 13h against the flat tool J1 with the contacts 12 being sandwiched. The pressing tool J2 is pressed against the pressed section 12a by a pressing force of an extent to plastic-deform the solder balls 13h. At this time, the pressing tool J2 is pressed against the pressed section 12a of the contacts 12 while avoiding the housing 11. Therefore, the force is efficiently transmitted to the solder balls 13h. The solder balls 13h are softer than the contacts 12. Accordingly, even after the solder balls 13h are secured to the respective contacts 12, the solder balls 13h may be deformed without affecting the forms of the contacts 12.

The solder balls 13h are deformed by being pressed against the flat tool J1, and flat surface 13a (see FIG. 4) in the plane along the flat tool J1 is formed at portions abutting with the flat tool J1. The connector 1 shown in FIGS. 1 to 4 is thus completed. In the process of manufacturing the connector 1, each of the solder balls 13h (see FIG. 5) is pressed against the plane portion of the flat tool J1. Accordingly, in the completed connector 1, as shown in FIGS. 3 and 4, all of the flat sections 13a of the solder balls 13 form the common plane P.

In order to facilitate deformation of the solder balls 13h, the flat tool J1 may be vibrated (including ultrasonic vibration) in the upward and downward direction UD or a lateral direction perpendicular to the upward and downward direction UD during the pressing. Instead, a situation where the solder balls 13h are heated to an extent where the balls are not fused may be adopted.

Next, mounting of the connector 1 onto the circuit board will be explained.

FIG. 6 illustrates a state in which the connector shown in FIGS. 1 to 4 is mounted on the circuit board.

Metal conductor traces 102 are formed on a surface of the circuit board 100 shown in FIG. 6. Solder paste 103 including flux is applied onto the conductor traces 102. The tops of the solder paste 103 on the respective conductor traces 102 are aligned so as to be contacted with the common plane. In order to fundamentally view the structure of the conductor traces 102 and the solder paste 103, FIG. 6 shows the thicknesses of the conductor traces 102 and the solder paste 103 in an extremely exaggerated manner. Before mounting of the connector, when the solder paste 103 is applied onto the conductor traces 102, a metal mask (not illustrated) in which openings are formed corresponding to the positions of the conductor traces 102 is put, and solder paste agent is applied thereon. At this time, if the conductor pattern 102 is narrow with respect to the thickness of the metal mask, the openings of the metal mask corresponding thereto become also smaller. Accordingly, the solder paste accumulates in the openings of the metal mask when the metal mask is removed after applied. The application onto the conductor pattern 102 may be incomplete. Thus, it is required to thin the metal mask depending on that the width of the conductor pattern 102 is narrowed according to the trend toward higher pitch. As a result, according to the trend toward higher pitch, the thickness of the solder paste 103 has become thinner. With an electronic component in which the solder pieces are preliminarily attached to the contacts used for connection with a substrate, a method of only applying flux instead of the solder paste 103 may be adopted.

As shown in FIG. 6, the connector 1 is mounted on the circuit board 100 in the mounting position in which the underside 11b of the housing 11 faces the circuit board 100 and the contacts 12 face the circuit board 100. The flat sections 13a of the solder balls 13 secured to the respective contacts 12 are aligned so as to form the common plane P (FIGS. 3 and 4). Accordingly, in a state in which the connector 1 is mounted on the circuit board 100, all of the solder balls 13 are contacted with the solder paste 103 of the circuit board 100 at the respective flat sections 13a.

In this state, heating is applied by a reflow process, and the solder balls 13 are fused to the conductor traces 102. Accordingly, all the contacts 12 are electrically coupled to the conductor traces 102 of the circuit board 100, and a connection failure does not occur with each of the contacts 12.

Next, various shapes of the contacts from the connector 1 according to the invention will be described

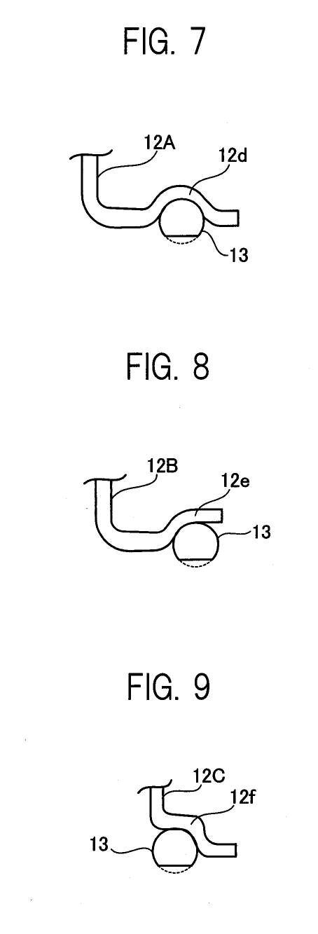

A contact 12A of a connector shown in FIG. 7 includes a recess 12d in which the solder ball 13 is inserted. More specifically, the contact 12A has a shape in which a portion to fix the solder ball 13 is curved to be upwardly convex along the external form of the solder ball 13. The solder ball 13 is secured to the inwardly bowed recess 12d.

A contact 12B of the connector shown in FIG. 8 is provided with an upwardly bent recess 12e at a tip portion. The solder ball 13 is secured to the recess 12d of the tip portion of the contact 12B.

A contact 12C of the connector shown in FIG. 9 is provided with a recess 12f at a portion laterally bent after extending downward. The solder ball 13 is secured to the recess 12f.

The respective various contacts shown in FIGS. 7 to 9 are securely positioned while the solder ball 13 is mechanically reinforced and secured. Accordingly, the solder balls 13 are not displaced or fall off when a force to form the flat sections is applied to the solder balls 13 during manufacturing.

Next, another embodiment of the invention will be described. In the description of this embodiment, in the following, elements identical to those described above are assigned with the same reference signs. Differences between the embodiments will be described.

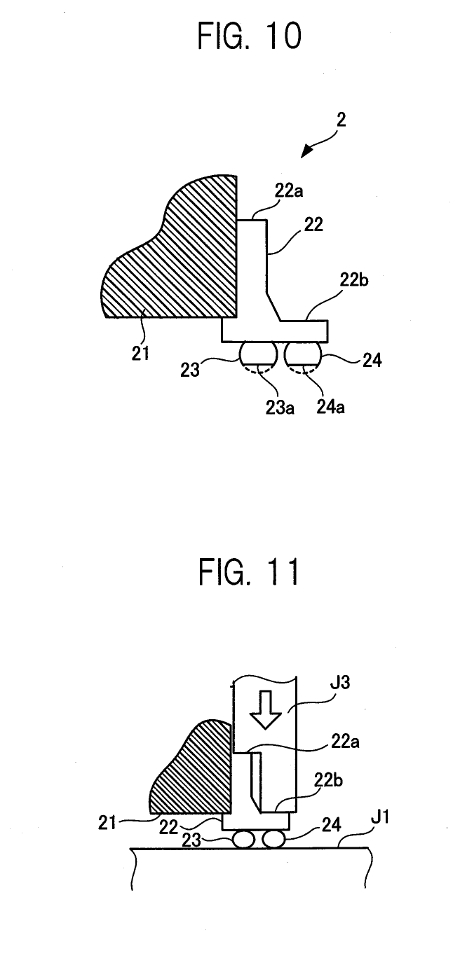

In a connector 2 shown in FIG. 10, a contact 22 is formed by stamping a metal plate, and arranged protruding from both an underside and a side of a housing 21. An upper portion of a protruding portion of the contact 22 is formed in a step-like manner, and a lower portion thereof is flat. Two solder balls 23 and 24 are secured to the underside of the contact 22. As with the first embodiment, the solder balls 23 and 24 include respective flat sections 23a and 24a facing downward. In the connector 2, electric current paths are formed in parallel by two solder balls 23 and 24 for one contact 22. This reduces the impedance of the solder balls, and increases current capacity. Accordingly, increase in impedance and reduction in current capacity are avoided even if the solder balls are minimized due to the trend toward higher pitch.

The contact 22 of the connector 2 shown in FIG. 10 includes the step-like upper portion. The contact 22 also includes a first pressed section 22a, against which the pressing tool is pressed, on an upper stage close to the housing 21. The contact 22 further includes a second pressed section 22b on a lower stage.

In order to manufacture the connector 2 shown in FIG. 10, the contact 22 is secured to the housing 21, solder balls 23 and 24 are secured to the contact 22, and the thus secured assembly is mounted on the flat tool J1 as shown in FIG. 11. Next, a pressing tool J3 is pressed against the first and second pressed sections 22a and 22b of the contact 12, thereby pressing the solder balls 23 and 24 against the flat tool J1, while sandwiching the contact 22 therebetween. The pressing tool J3 is pressed against the first and second pressed sections 22a and 22b of the contact 22 while avoiding the housing 21.

The solder balls 23 and 24 are pressed by the flat tool J1 and thereby deformed. Flat surfaces 23a and 24a (see FIG. 10), which are a plane along the flat tool J1, are formed at portions contacted with the flat tool J1. The connector 2 shown in FIG. 10 is completed in this manner.

Next, a variation different in the shape of the contact from the connector 2 will be described.

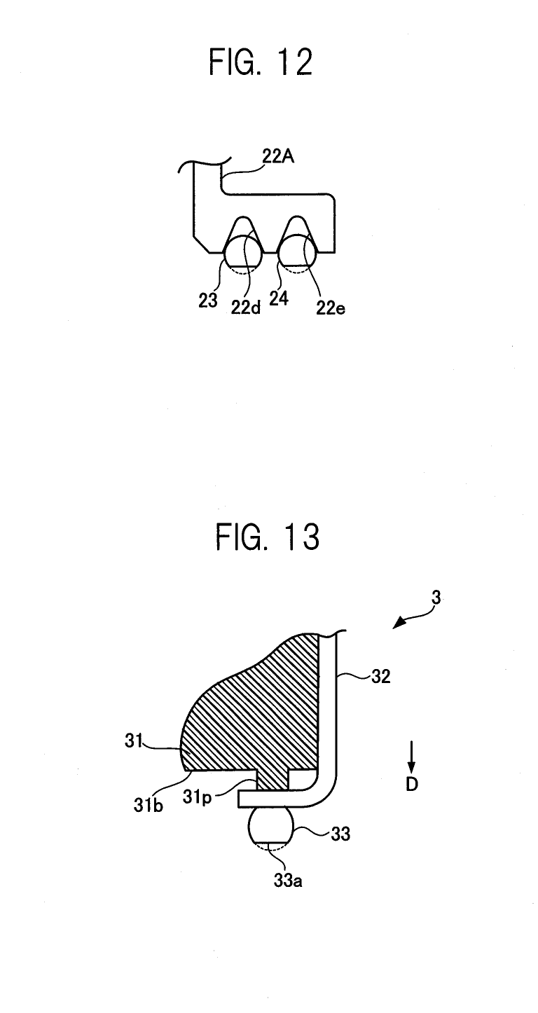

A contact 22A of the connector shown in FIG. 12 includes recesses 22d and 22e into which the solder balls 23 and 24 are inserted, respectively. More specifically, the recesses 22d and 22e are wedge-shaped notches formed in the contact 22A. The solder balls 23 and 24 are secured to the recesses 22d and 22e, respectively.

In the contact 22A of the variation shown in FIG. 12, fixation of the solder balls 23 and 24 is mechanically reinforced. Accordingly, even when a force to form the flat sections are applied to the solder balls 23 and 24 in the manufacturing process, the solder balls 13 are not displaced or fallen off.

Next, another embodiment of the invention will be described. In the following description of this embodiment, elements identical to those having been described in the above embodiments are assigned with the same reference signs. Differences from the above embodiments will be described.

In a connector 3 shown in FIG. 13, a contact 32 extends along a side of a housing 31 in the downward direction D, the extended distal portion is bent and further extends below the housing 31. A protrusion 31p protruding in the downward direction D is positioned on the underside 31b of the housing 31. The contact 32 is contacted with the protrusion 31p of the housing 31. The solder ball 33 is secured to the other side of a portion of the contact 32 with which the protrusion 31p is contacted. That is, the protrusion 31p of the housing 31 is opposed to the solder ball 33 secured to the contact 32 across the contact 32 therebetween. The flat surface 33a is positioned along the solder ball 33.

Here, the protrusion 31p of the housing 31 corresponds to an example of the contact face section according to the invention.

In manufacturing the connector 3 shown in FIG. 13, when the flat surface 33a is formed, a solder ball on which the flat surface has not been formed yet is pressed against the flat tool J11 (see FIG. 5), thereby pressing the housing 31 against the flat tool J1. At this time, the protrusion 31P of the housing 31 presses the solder ball 33 against the flat tool J1 (see FIG. 5) through the contact 32. The protrusion 31p efficiently transmits the force; the solder ball 33 is plastic-deformed without deforming the contact 32, thus forming the flat surface 33a.

Next, yet another embodiment of the invention will be described. In the following description of this embodiment, elements identical to those having been described in the above embodiments are assigned with the same reference signs. Differences from the above embodiments will be described.

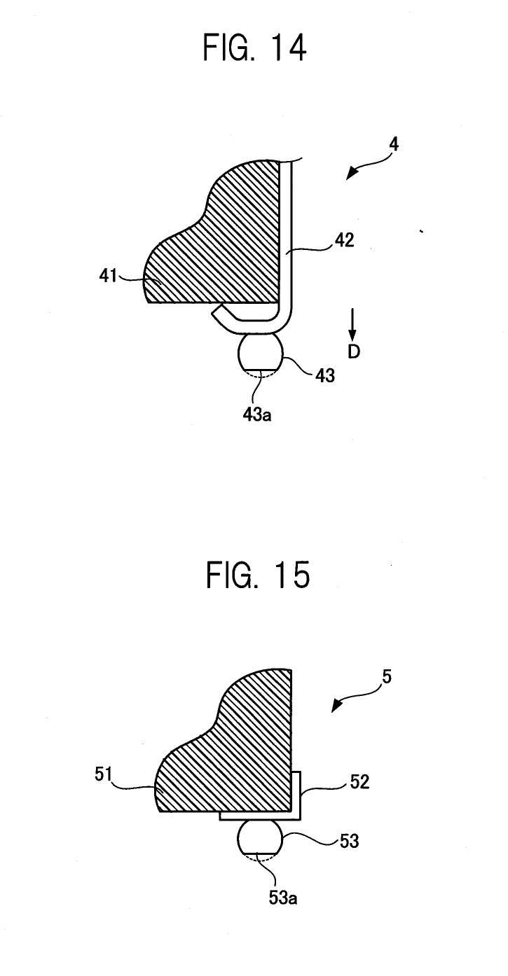

In a connector 4 shown in FIG. 14, a contact 42 extends along a side of a housing 41 in the downward direction D, the extended tip portion is bent and further extends below the housing 41. The tip of the contact 42 is further bent to the housing 41 and contacted with the housing 41.

A solder ball 43 is secured to a position between the portion of the contact 42 secured to the side of the housing 41 and the tip portion contacted to the housing 41. A flat surface 43a is positioned at the solder ball 43.

In manufacturing the connector 4 shown in FIG. 14, even when the flat surface 43a is formed, the solder ball is pressed against the flat tool J1 (see FIG. 5) using the housing 41. At this time, forces are efficiently applied by both of the tip portion of the contact 42 secured to the side of the housing 41 and the portion contacted to the housing 41. The solder ball 43 is thus plastic-deformed and the flat surface 43a is formed.

Next, another embodiment of the invention will be described. In the following description of this embodiment, elements identical to those having been described in the above embodiments are assigned with the same reference signs. Differences from the above embodiments will be described.

In a connector 5 shown in FIG. 15, a contact 52 is closely adhered to at least an underside of the housing 51. More specifically, the contact 52 is closely adhered to the underside and a side of the housing 51. The contact 52 is formed by metallic plating. However, this contact may be formed by vapor deposition or adhesion instead. A solder ball 53 is secured to the contact 52. A flat surface 53a is positioned at the solder ball 53.

Here, a portion of the housing 51 at which the contact 52 is formed corresponds to an example of the contact face section according to the invention.

In manufacturing the connector 5 shown in FIG. 15, even when the flat surface 53a is formed, the solder ball is pressed against the flat tool J1 (see FIG. 5) using the housing 51. At this time, a force is efficiently transmitted by the contact 52. The solder ball 53 is thus deformed and the flat surface 53a is formed.

In the above embodiments, the solder ball is illustrated as an example of the solder piece of the invention. However, the solder piece according to the invention is not limited to a piece with a shape like a ball or a dome. For instance, the piece may be pillar-shaped or pyramid-shaped instead. Further, the piece may be a block having a shape in which balls are arranged in contact with each other.

In the above embodiments, the description is made in that the contact is a member to be contacted with a mating connector. However, the terminals recited in the invention are not limited this. Instead, anything facing the circuit board may be adopted, and the terminal may be another member different from a member contacted with a mating connector.

In the embodiment shown in FIGS. 1-9, the example of the connector in which contacts are arranged in two rows each including 80 pieces is described. However, the number of terminals in the invention may be any number, at least three in a case of a one row arrangement and at least four in a case of a plural rows arrangement.

In the above embodiments, the example of the connector with the structure in which the contacts are arranged in two rows is described. However, the electrical component according to the invention is not limited to an electrical connector as shown. Instead, the component may be a ball grid array type connector. In the embodiments, the example of the connector to be mated with a mating connector is described. However, the electrical component according to the invention is not limited to this. For instance, the component may be an IC socket or an IC package to be surface-mounted to a circuit board using solder balls.

In the embodiments, the example of plastic-deforming the solder ball by pressing the ball against the flat tool J1, as a method of forming the flat surface of the solder ball is described. However, the method of forming the flat surface is not limited to this. For instance, the surface may be formed by polishing the solder ball against a polishing surface.

According to different embodiments discussed, in the electrical connector according to the invention, it is preferable that each of the terminals includes a recess into which each of the solder pieces is inserted.

Since the solder pieces are inserted into the recesses of the terminal, the solder pieces are securely positioned. In manufacturing the electrical connector, even when a force for forming the flat sections is applied to the solder pieces, displacement of the solder piece may be prevented.

As described above, according to the invention, the an electrical connector suppresses an occurrence of connection failure with a terminal when being surface-mounted on a circuit board.

Although several embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A surface mount connector, comprising:
a housing;
contacts secured to the housing; and
solder pieces of each contact having flat sections that form a common plane across the contacts.

2. The connector according to claim 1, wherein each of the contacts includes a pressed section against which a tool pressing the solder pieces is urged while avoiding the housing.

3. The connector according to claim 1, wherein the housing includes a contact face section contacting each of the contacts.

4. The connector according to claim 3, wherein the contact face section faces the solder pieces.

5. The connector according to claim 1, wherein each of the contacts includes a recess into which each of the solder pieces is inserted.

6. The connector according to claim 1, wherein the solder pieces include flat sections facing downwardly.

7. The connector according to claim 6, wherein the flat sections are flat surfaces, and form the common plane.

8. The connector according to claim 7, wherein the flat sections form the common plane.

9. The connector according to claim 1, wherein at least one of the contacts is profiled to be curved upwardly convex around the at least one of the solder pieces, forming an inwardly bowed recess.

10. The connector according to claim 9, wherein the at least one of the solder pieces is secured to the inwardly bowed recess.

11. The connector according to claim 1, wherein at least one of the contacts further comprises an upwardly bent recess at a tip portion.

12. The connector according to claim 11, wherein the at least one of the solder pieces is secured to the upwardly bent recess.

13. The connector according to claim 1, wherein at least one of the contacts further comprises a recess at a portion laterally bent after extending downward.

14. The connector according to claim 13, wherein the at least one of the solder pieces is secured to the recess.

15. The connector according to claim 14, wherein the solder pieces are mechanically reinforced and secured to the housing to withstand a tool force forming the flat sections.
